(19) United States
(12) Patent Application Publication
(10) Pub. No.: US 2017/0348710 A1
(43) Pub. Date: Dec. 7, 2017

(54) SPRAY GUN

(71) Applicant: ANEST IWATA Corporation, Kanagawa (JP)

(72) Inventors: Masaru KANEKO, Kanagawa (JP); Takayuki HATA, Kanagawa (JP)

(73) Assignee: ANEST IWATA CORPORATION, Kanagawa (JP)

(21) Appl. No.: 15/538,357

(22) PCT Filed: Dec. 18, 2015
(86) PCT No.: PCT/JP2015/085453

§ 371 Date: Jun. 21, 2017

(30) Foreign Application Priority Data
Dec. 22, 2014 (JP) 2014-258282

(51) Int. Cl. B05B 7/00; B05B 7/06; B05B 7/12; B05B 7/08; B05B 1/04; B05B 7/02

(52) U.S. Cl. CPC B05B 7/0081; B05B 7/1209; B05B 7/0838; B05B 7/068; B05B 7/025; B05B 1/04

(57) ABSTRACT

A spray gun including a nozzle portion in which a substantially V-shaped groove is formed in a circular section of a truncated conical front end with a cone angle ranging from 20° to 90°, and an internal hole is opened as a liquid ejecting port by forming the substantially V-shaped groove; and a gas cap including a cap face which is provided with an atomized gas opening portion having an opening diameter larger than the circular section, the gas cap forming a circular slit-like gap between the gas cap and an outer periphery of the truncated conical front end, the gap being configured to eject gas for atomizing liquid. The circular section of the truncated conical front end has a diameter ranging from 0.8 mm to 2.8 mm. The atomized gas opening portion has the opening diameter equal to or larger than 1.0 mm and smaller than 3.0 mm.

### TECHNICAL FIELD

The invention relates to spray guns.

### BACKGROUND ART

One of spray guns that have been known is a low-pressure atomizing air spray gun. The low-pressure atomizing air spray gun has a nozzle tip that is formed to have a front end with a truncated conical outer shape and include a circular cross-sectional internal hole to which a substantially V-shaped cross-sectional groove is formed to create a lip-like opening. Through this nozzle tip, the spray gun ejects paint at a pressure ranging from 1 to 6 kgf/cm², and atomizes the sprayed paint by using a compressed air flow under a pressure ranging from 0.5 to 2 kgf/cm². The spray gun has an air cap that creates an annular air ejection flow between the outer periphery of the front end of the nozzle tip and the central hole of the air cap. The front end face of the nozzle tip is located within an area where an annular air hole is formed between the front end face and the central hole of the air cap. (Patent Document 1)

In the Patent Document 1, spray air pressure is set low to solve a problem associated with high spray air pressure which is the most common cause of paint scattering during air spray. The spray gun disclosed in the Patent Document 1 achieves sufficient atomization even with the low spray air pressure, and uses a simple device to perform spray painting without using a device like a special high-pressure pump.

According to the description about the operation disclosed in the Patent Document 1, more specifically, the paint that is ejected from the nozzle at a pressure high enough to eject the paint is ejected from the lip-like opening through the groove in the front end of the nozzle, in the form of a flat flow in a folding-fan shape. The paint is atomized by colliding with an air flow ejected from the annular air opening that is formed by the conical outer periphery of the nozzle and the central hole of the air cap. Immediately after being atomized in the central hole, the paint is further atomized by colliding with the air flow that is ejected from auxiliary air holes opened on minor-diameter sides of the nozzle tip opening.

In the downstream thereof, a substantially rectangular spray flow is created by an air flow that is discharged from auxiliary air holes opened on major-diameter sides of the nozzle tip opening to collide with the paint. Subsequently, in the further downstream, air flows ejected from a pair of horn air holes formed on the major-diameter sides further atomize the spray flow that is not sufficiently atomized. Eventually, the whole paint is thoroughly atomized.

### CITATION LIST

### Patent Document

Patent Document 1: Japanese Examined Patent Application Publication No. H07-024796

### SUMMARY OF INVENTION

### Technical Problem

The method disclosed in the Patent Document 1 includes multiple steps of spray impingement of the air flow from a large number of auxiliary air holes against the paint for sufficient atomization, so that a large number of air holes need to be formed in the air cap. This complicates the structure of the air cap (gas cap).

The present invention has been made in light of the above-mentioned circumstances. An object of the invention is to provide a spray gun capable of setting a spray gas pressure at a relatively low middle-low pressure and performing good atomization without making auxiliary gas holes in a gas cap.

### Solution to Problem

Spray gas pressure can be set at relatively low middle-low pressure and a good atomization is performed without providing a gas cap with auxiliary gas holes.

The spray gun of the invention includes a nozzle portion in which a substantially V-shaped groove is formed in a circular section of a truncated conical front end with a cone angle ranging from 20° to 90°, and an internal hole is opened as a liquid ejecting port by forming the substantially V-shaped groove; and a gas cap including a cap face which is provided with an atomized gas opening portion having an opening diameter larger than the circular section, the gas cap forming a circular slit-like gap between the gas cap and an outer periphery of the truncated conical front end, the gap being configured to eject gas for atomizing liquid. The circular section of the truncated conical front end has a diameter ranging from 0.8 mm to 2.8 mm. The atomized gas opening portion has the opening diameter that is equal to or larger than 1.0 mm and smaller than 3.0 mm. The gas is ejected from the circular slit-like gap at a flow rate ranging from 40 L/min to 160 L/min and an ejection velocity ranging from 100 m/sec to 2900 m/sec, so that the liquid can be atomized without providing the cap face with auxiliary gas ejecting holes for atomizing the liquid.

The invention will be understood through the following configuration.

(1) The invention provides a spray gun comprising a nozzle portion in which at least one substantially V-shaped groove is formed in a circular section of a truncated conical front end with a cone angle ranging from 20° to 90°, and an internal hole is opened as a liquid ejecting port by forming the substantially V-shaped groove; and a gas cap including a cap face which is provided with an atomized gas opening portion having an opening diameter larger than the circular section, the gas cap forming a circular slit-like gap, which ejects gas for atomizing liquid ejected from the liquid ejecting port, between the gas cap and an outer periphery of the truncated conical front end, in which the circular section of the truncated conical front end has a diameter ranging from 0.8 mm to 2.8 mm; in which the atomized gas opening portion has the opening diameter that is equal to or larger than 1.0 mm and smaller than 3.0 mm; and in which a flow rate of the gas ejected from the circular slit-like gap ranges from 40 L/min to 160 L/min; and an ejection velocity of the gas ejected from the circular slit-like gap ranges from 100 m/sec to 2900 m/sec, so that the liquid can be atomized without providing the cap face with auxiliary gas ejecting holes for atomizing the liquid.
(2) In the configuration according to (1), a supply pressure of the gas at a gas supply port ranges from 0.07 MPa to 0.25 MPa, and a supply pressure at a time when the gas is introduced into the circular slit-like gap ranges from 0.05 MPa to 0.2 MPa.
(3) In the configuration according to (1) or (2), the gas cap includes horn portions having a gas channel extending from an outer periphery of the cap face in an ejecting direction of the liquid, and the horn portion is provided with a pattern-adjusting gas ejecting port that opens in the gas channel, the pattern-adjusting gas ejecting port being configured to eject gas toward the liquid that is atomized and adjust a spray pattern shape with respect to a target to be applied with the atomized liquid.
(4) In the configuration according to any one of (1) to (3), the truncated conical front end of the nozzle portion is located between where the truncated conical front end is in plane with an end face of the atomized gas opening portion of the cap face, the end face being located on a downstream side of the liquid ejecting direction, and 0.6 mm inside the gas cap or 0.4 mm outside the end face of the atomized gas opening portion, which is located on the downstream side of the liquid ejecting direction.
(5) In the configuration according to any one of (1) to (4), the configuration includes a liquid nozzle disposed on a front end side of a spray gun body and including a nozzle tip position adjuster on the downstream side of the liquid ejecting direction; a nozzle tip provided as the nozzle portion that is disposed with a rear end-side portion inserted in the nozzle tip position adjuster; and a nozzle tip holder including an opening through which a front end-side portion of the nozzle tip is inserted and configured to fix the nozzle tip to the liquid nozzle. The nozzle tip has a tapered portion in which an external diameter of a rear-end outer peripheral surface is reduced toward a rear end. The liquid nozzle has such a shape that an internal diameter of the nozzle tip position adjuster is reduced toward a rear end of the liquid nozzle correspondingly to the tapered portion of the nozzle tip.

A female thread structure that is threadedly engaged with the nozzle tip holder is formed in a front end-side inner peripheral surface of the liquid nozzle. A male thread structure that is threadedly engaged with the female thread structure of the liquid nozzle is formed in a rear end-side outer peripheral surface of the nozzle tip holder. The tapered portion of the nozzle tip is inserted in the nozzle tip position adjuster of the liquid nozzle. The nozzle tip holder is then attached to the liquid nozzle so that the front end of the nozzle tip passes through the opening of the nozzle tip holder. At the same time, the nozzle tip holder is threadedly engaged with the liquid nozzle to fix the nozzle tip to the liquid nozzle. The tapered portion of the nozzle tip is thus tightly sealed to the nozzle tip position adjuster, and the nozzle tip is positioned coaxially with the liquid nozzle.

### BRIEF DESCRIPTION OF DRAWINGS

FIG. 1 is a cross-sectional view of a spray gun according to an embodiment of the invention.

FIG. 2 is an exploded cross-sectional view of a liquid nozzle, a nozzle tip, and a nozzle tip holder according to an embodiment of the invention.

FIG. 3A is a perspective view of the nozzle tip according to an embodiment of the invention, and FIG. 3B is a partially cut away view of the nozzle tip shown in FIG. 3A.

FIG. 4A is a perspective view of the liquid nozzle, the nozzle tip, and the nozzle tip holder according to an embodiment of the invention, which are assembled together, and FIG. 4B is an elevation view of FIG. 4A.

FIG. 5 a partial elevation view of the spray gun according to an embodiment of the invention.

FIGS. 6A and 6B shows a modification example of the nozzle tip according to an embodiment of the invention and corresponds to FIGS. 4A and 4B.

### DESCRIPTION OF EMBODIMENTS

Modes for carrying out the invention (hereinafter, referred to as embodiments) will be explained below in detail with reference to the attached drawings. The same constituent elements will be provided with the same reference marks throughout the description of the embodiments.

In the following explanation, the terms “front end (side)” and “front” refer to a position or direction on the downstream side of a liquid flowing direction (liquid ejecting direction) in each part. The terms “rear end (side)” and “rear” refer to a position or direction on the upstream side of the liquid flowing direction (direction opposite to the liquid ejecting direction).

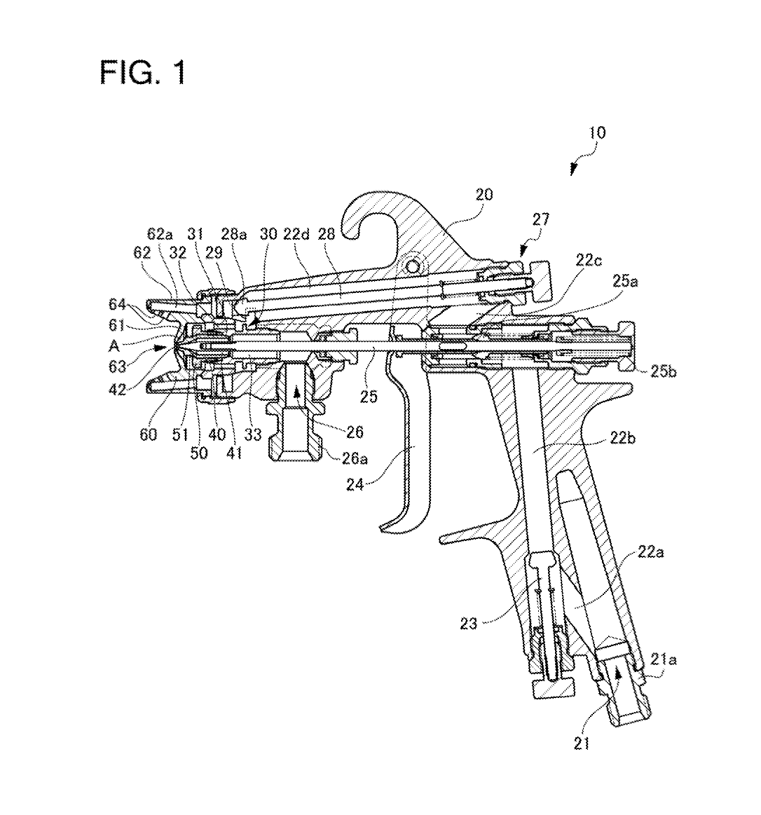

FIG. 1 is a cross-sectional view of a spray gun 10 according to an embodiment of the invention.

As shown in FIG. 1, the spray gun 10 includes a spray gun body 20, a liquid nozzle 30 having a nozzle tip position adjuster 31 on the liquid ejecting direction side, which is located on a front end side of the spray gun body 20, a nozzle tip 40 provided as a nozzle portion that is disposed with a rear end-side portion inserted in the nozzle tip position adjuster 31 of the liquid nozzle 30, a nozzle tip holder 50 having an opening through which a front end-side portion of the nozzle tip 40 passes and configured to fix the nozzle tip 40 to the liquid nozzle 30, and a gas cap 60 disposed on a front end-side portion of the nozzle tip 40.

The spray gun body 20 has a gas supply port 21 through which gas is supplied. A gas supply pipe (not shown) for supplying the gas is connected to the gas supply port 21. The gas supplied from the gas supply port 21 passes through a gas channel 22a. After a flow rate of the gas is adjusted by a whole gas flow rate regulation valve 23, the gas is supplied to a gas channel 22b.

The present embodiment describes a state in which an attachment component 21a for detachably attaching the gas supply pipe (not shown) to the spray gun body 20 is disposed in the gas supply port 21. However, a method for attaching the gas supply pipe (not shown) to the spray gun body 20 is not limited to the above-mentioned method which uses the attachment component 21a. The attaching method may be properly changed.

There is no particular limitation in kinds of the gas that is supplied to the gas supply port 21. The gas may be chosen from air, nitrogen, argon, etc., as appropriate.

The gas supplied to the gas channel 22b is subsequently supplied to an on-off valve 25a that is disposed in a needle 25 configured to move in a front-back direction by an operation of a trigger 24. The on-off valve 25a is movable in the front-back direction with the needle 25.

When the needle 25 is operated to move rearward by the operation of the trigger 24, the on-off valve 25a also moves rearward, and the gas supplied to the on-off valve 25a is supplied to a gas channel 22c.

The gas supplied to the gas channel 22c is further supplied through a gas channel 22d to a gas cap 60 side.

A front end 28a of a needle 28 of a pattern adjuster 27 is located on a front end side of the gas channel 22d, so that a position of the front end 28a can be adjusted in the front-back direction by operating the pattern adjuster 27.

An opening degree of an opening 29 therefore can be adjusted in a range between a fully closed position and a fully open position by adjusting the position of the front end 28a of the needle 28. The gas is supplied through the opening 29 to a horn portion 62 side. The horn portion 62 extends from an outer periphery of a cap face 61 of the gas cap 60 in a liquid ejecting direction.

The gas supplied to the horn portion 62 is ejected from pattern-adjusting gas ejecting ports 64 so as to be blown toward atomized liquid which has been atomized through atomization of the liquid that is ejected from the front end of the nozzle tip 40 due to the gas ejected from an atomized gas opening portion 63 of the cap face 61.

The gas supplied through the gas channel 22d to the opening 29 side diverges before the gas that is not supplied to the horn portion 62 side reaches the opening 29, according to the opening degree of the opening 29 which is determined by the position of the front end 28a of the needle 28.

The gas that has diverged is supplied through gas channels 32 of the liquid nozzle 30 to a space A around the nozzle tip 40, which is located behind the cap face 61.

The gas supplied to the space A is ejected outside through a circular slit-like gap that is formed by an outer periphery of the front end of the nozzle tip 40 and the atomized gas opening portion 63 of the cap face 61 and extends along the outer periphery of the front end of the nozzle tip 40.

The spray gun body 20 has a liquid supply port 26 to which liquid is supplied. A liquid supply pipe (not shown) for supplying liquid is connected to the liquid supply port 26.

The embodiment describes a state in which the attachment component 26a for detachably attaching the liquid supply pipe (not shown) to the spray gun body 20 is disposed in the liquid supply port 26. However, a method for attaching the liquid supply pipe (not shown) to the spray gun body 20 is not limited to the above-mentioned method which uses the attachment component 26a. The attaching method may be properly changed.

The liquid supplied to the liquid supply port 26 is supplied through a liquid channel 33 of the liquid nozzle 30 into a liquid channel 41 of the nozzle tip 40.

A liquid ejecting port 42 for ejecting liquid is formed in the front end of the nozzle tip 40.

A front end of the needle 25 is inserted in the liquid ejecting port 42 so as to be in contact with the liquid ejecting port 42 due to a biasing force of an elastic body 25b which is disposed on the rear end side of the needle 25 and made up of a coil spring. While the front end of the needle 25 is in contact with the liquid ejecting port 42, the liquid ejecting port 42 is blocked with the front end of the needle 25.

The liquid is not ejected from the liquid ejecting port 42 unless the trigger 24 is pulled. The liquid is ejected from the liquid ejecting port 42 when the trigger 24 is pulled.

As described above, the operation of the trigger 24 doubles as an opening/closing operation of the on-off valve 25a which controls the ejection of the gas. When the trigger 24 is pulled, therefore, the liquid is ejected from the liquid ejecting port 42 of the nozzle tip 40, and simultaneously, the gas is ejected from the circular slit-like gap that is formed by the outer periphery of the front end of the nozzle tip 40 and the atomized gas opening portion 63 of the cap face 61, and ejected also from the pattern-adjusting gas ejecting ports 64.

The following explains in more detail about the liquid nozzle 30, the nozzle tip 40, the nozzle tip holder 50, and the gas cap 60.

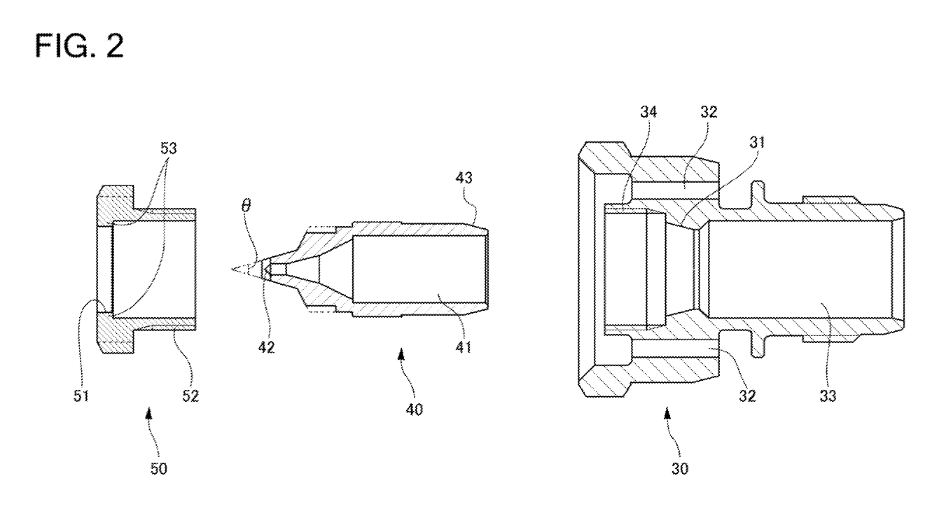

FIG. 2 is an exploded cross-sectional view of the liquid nozzle 30, the nozzle tip 40, and the nozzle tip holder 50.

(Liquid Nozzle)

As shown in FIG. 1, the liquid nozzle 30 is disposed on the front end side of the spray gun body 20 and thus makes up an attachment portion to which the nozzle tip 40 provided as the nozzle portion is attached.

As shown in FIG. 2, the liquid nozzle 30 has the nozzle tip position adjuster 31 for adjusting the position of the nozzle tip 40 provided as the nozzle portion as described above.

The nozzle tip position adjuster 31 has a shape in which an internal diameter is reduced toward the rear end side correspondingly to a tapered portion 43 having an external diameter that is reduced toward the rear end side and formed in a rear end outer peripheral surface of the nozzle tip 40.

A female thread structure 34 that is threadedly engaged with the nozzle tip holder 50 is formed in an inner peripheral surface of the front end-side portion of the liquid nozzle 30. In the outside of the nozzle tip position adjuster 31 and the female thread structure 34, the plurality of gas channels 32 are formed around the nozzle tip position adjuster 31 and the female thread structure 34.

(Nozzle Tip)

The nozzle tip 40 is a portion that makes up the nozzle portion configured to eject the liquid supplied from the liquid nozzle 30 side. As shown in FIG. 1, the nozzle tip 40 is disposed so that the tapered portion 43 on the rear end side is inserted in the nozzle tip position adjuster 31 of the liquid nozzle 30. The nozzle tip 40 is thus fixed to the liquid nozzle 30 by the nozzle tip holder 50.

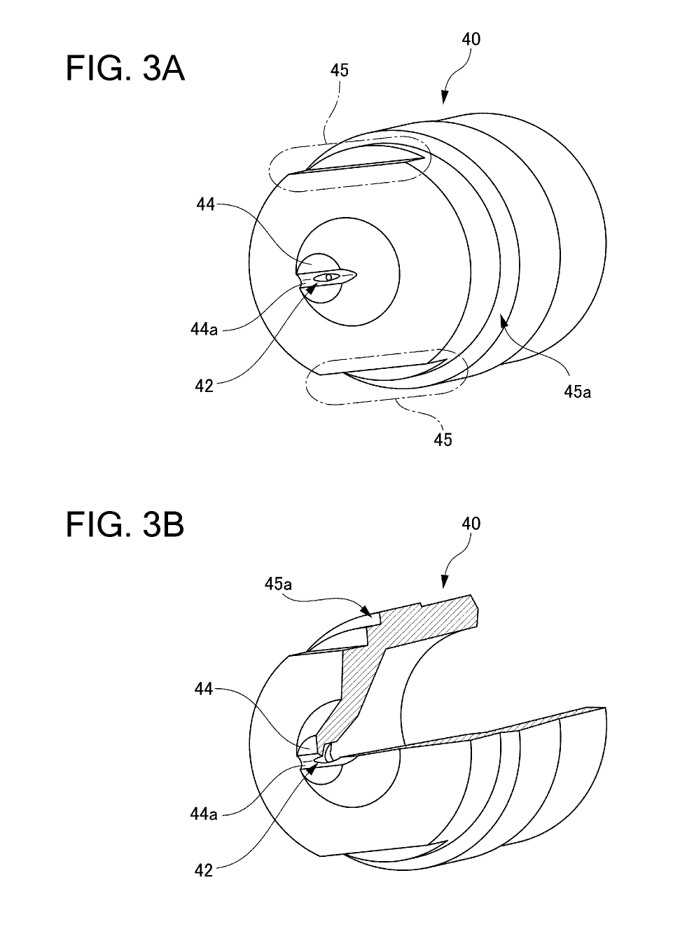

FIG. 3A is a perspective view of the nozzle tip 40, and FIG. 3B is a perspective view of the nozzle tip 40 shown in FIG. 3A, which is partially cut away to show the inside thereof.

As is apparent from FIGS. 3A and 3B, a substantially V-shaped groove 44a is formed in a circular section 44 of a truncated conical front end of the nozzle tip 40. An internal hole is opened by forming the substantially V-shaped groove 44a to make a liquid ejecting port 42 having an oval shape as viewed in a front view.

The truncated conical portion is formed to have a cone angle θ shown in FIG. 2 ranges from 20° to 90°.

When the nozzle tip 40 is positioned as shown in FIGS. 1 and 2, the substantially V-shaped groove 44a extends in a vertical direction as viewed in the drawings.

Since the liquid ejecting port 42 is formed in the above-described manner, the liquid ejected from the liquid ejecting port 42 is ejected in a flat film-like shape due to the oval shape of an opening of the liquid ejecting port 42 as viewed in the front view and guidance by the substantially V-shaped groove 44a.

As shown in FIG. 3A, a stepped portion 45a with which the nozzle tip holder 50 is engaged is provided in a part of the outer periphery of the nozzle tip 40. As shown by dotted circles, a pair of grasped faces 45 are formed in a circumferential lateral face of a front part of the stepped portion 45a to be arranged in parallel with each other. The nozzle tip 40 thus can rotate around a central axis thereof. Accordingly, if the pair of grasped faces 45 formed in the front end portion are held by, for example, a spanner or the like, and the nozzle tip 40 is rotated around the central axis, the substantially V-shaped groove 44a of the front end portion of the nozzle tip 40 is adjusted to be at a regular position relative to the pattern-adjusting gas ejecting ports 64 of the gas cap 60 shown in FIG. 1.

As described above, the rear end outer peripheral surface of the nozzle tip 40 is provided with the tapered portion 43 (see FIG. 2) having the external diameter that is reduced toward the rear end.

Since the tapered portion 43 is provided as mentioned above, and the nozzle tip position adjuster 31 of the liquid nozzle 30 has the internal diameter that is reduced toward the rear end side correspondingly to the tapered portion 43, the tapered portion 43 and the nozzle tip position adjuster 31 are tightly fitted together to accomplish sealing between the nozzle tip 40 and the liquid nozzle 30, when the nozzle tip 40 is secured to the liquid nozzle 30 by the nozzle tip holder 50, and the nozzle tip 40 is automatically positioned coaxially with the liquid nozzle 30.

(Nozzle Tip Holder)

The nozzle tip holder 50 is configured to fix the nozzle tip 40 to the liquid nozzle 30. As shown in FIG. 2, a male thread structure 52 that is threadedly engaged with the female thread structure 34 of the liquid nozzle 30 is formed in the rear end-side outer peripheral surface of the nozzle tip holder 50.

The front end-side portion of the nozzle tip holder 50 is provided with an opening 51 through which the front end-side portion of the nozzle tip 40 passes. Formed in the opening 51 is a rib 53 to be engaged with the stepped portion 45a of the nozzle tip 40.

After the tapered portion 43 of the nozzle tip 40 is inserted in the nozzle tip position adjuster 31 of the liquid nozzle 30, the nozzle tip holder 50 is capped on the nozzle tip 40 so that the front end-side portion of the nozzle tip 40 passes through the opening 51. Subsequently, the nozzle tip holder 50 is threadedly engaged with and fastened onto the liquid nozzle 30 in such a way that the nozzle tip 40 is pressed toward the liquid nozzle 30. The nozzle tip 40 is thus fixed to the liquid nozzle 30 by the nozzle tip holder 50.

At this time, as described above, the tapered portion 43 of the nozzle tip 40 is tightly fitted to the nozzle tip position adjuster 31 of the liquid nozzle 30 to accomplish sealing between the nozzle tip 40 and the liquid nozzle 30. When the tight fit between the tapered portion 43 and the nozzle tip position adjuster 31 is accomplished, the nozzle tip 40 is automatically positioned coaxially with the liquid nozzle 30.

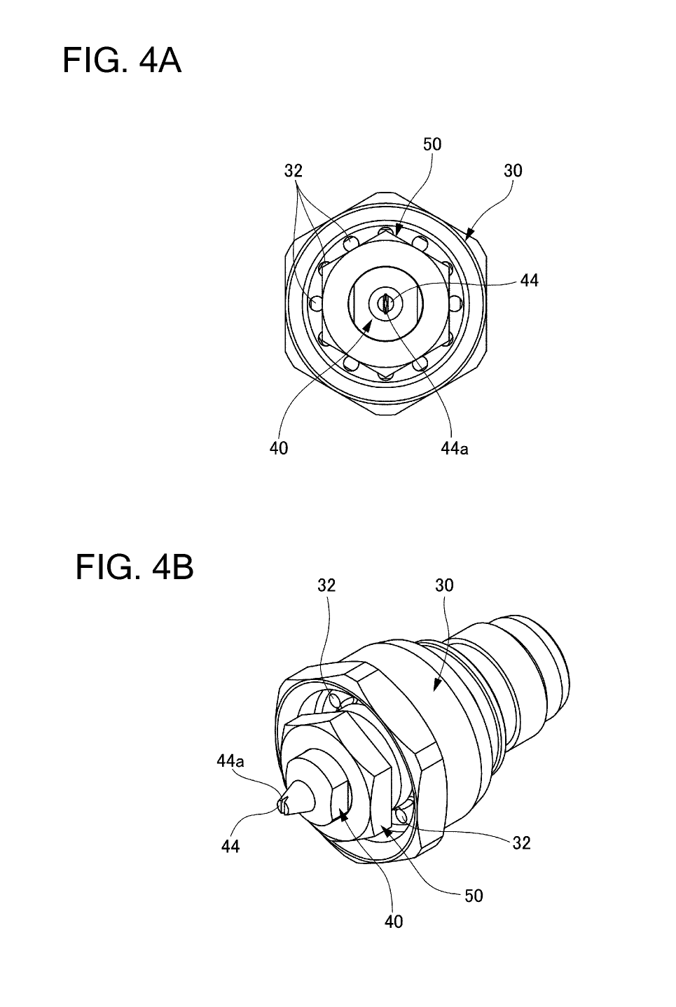

FIG. 4A is an elevation view showing a state in which the nozzle tip 40 is fixed to the liquid nozzle 30 by the nozzle tip holder 50, and FIG. 4B is a perspective view of FIG. 4A.

When the nozzle tip 40 shown in FIGS. 1 and 2 is positioned as illustrated in FIG. 4, the substantially V-shaped groove 44a extends in the vertical direction.

FIG. 4 omit the spray gun body 20 and merely show the liquid nozzle 30, the nozzle tip 40, and the nozzle tip holder 50.

As is clear from FIGS. 4A and 4B, the gas channels 32 formed on an outward side of the liquid nozzle 30 are arranged around the nozzle tip 40 at substantially regular intervals. The gas is therefore supplied evenly into the space A around the nozzle tip 40, which is behind the cap face 61, as described with reference to FIG. 1.

(Gas Cap)

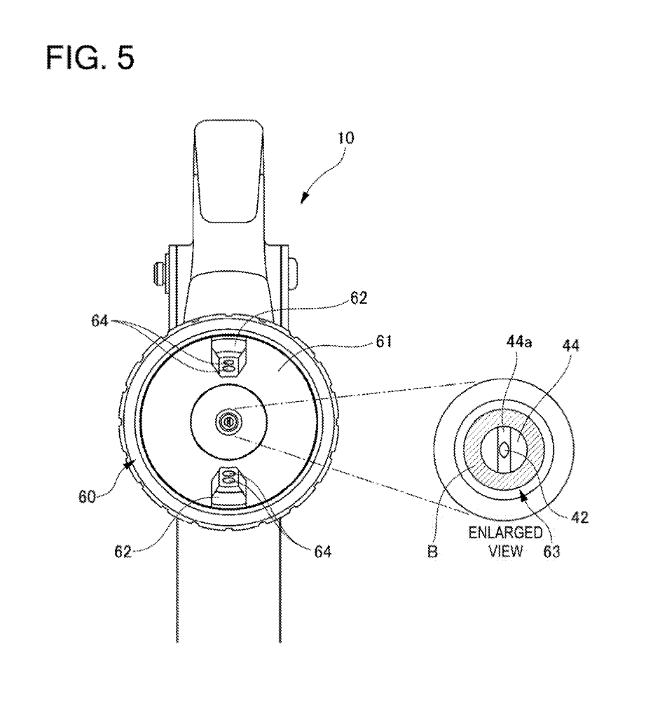

FIG. 5 is an elevation view of the gas cap 60 of the spray gun 10 and parts around the gas cap 60. FIG. 5 also shows an enlarged view of an area around the liquid ejecting port 42.

FIG. 5 further shows an example of a case in which the substantially V-shaped groove 44a of the front end portion of the nozzle tip 40 is adjusted to the regular position relative to the pattern-adjusting gas ejecting ports 64 of the gas cap 60. FIG. 5 shows a case in which, for example, both major-diametrical end portions of the opening of the liquid ejecting port 42 in a bottom of the substantially V-shaped groove 44a of the nozzle tip 40 are positioned on lines leading to the pattern-adjusting gas ejecting ports 64 of the gas cap 60, which are disposed with the nozzle tip 40 intervening therebetween.

As shown in FIGS. 1 and 5, the gas cap 60 has the cap face 61 with the atomized gas opening portion 63, and the horn portions 62 with the gas channels 62a extending from the outer periphery of the cap face 61 in the liquid ejecting direction.

The following description of the gas cap 60 relates mainly to how the gas cap 60 is associated with liquid atomization and also refers to a peripheral configuration including the atomized gas opening portion 63 of the cap face 61. The horn portion 62 will be described later.

As shown in the enlarged view of FIG. 5, the atomized gas opening portion 63 formed in the cap face 61 of the gas cap 60 has an opening diameter larger than a diameter of the circular section 44 of the truncated conical front end of the nozzle tip 40 which makes up the nozzle portion.

The outer periphery of the front end of the nozzle tip 40 and the atomized gas opening portion 63 of the cap face 61 form a circular slit-like gap (see a hatched part B of the enlarged view in FIG. 5) around the front end of the nozzle tip 40.

The liquid ejected from the front end of the nozzle tip 40 is atomized chiefly by the gas ejected from the circular slit-like gap.

Hereinafter, the hatched part B of the enlarged view in FIG. 5 is referred to as a gas ejecting portion B.

More specifically, the liquid ejected from the liquid ejecting port 42 in a flat film-like shape is covered with the gas that is ejected from the gas ejecting portion B in an annular shape.

Since the front end of the nozzle tip 40 has the shape like a truncated cone, the gas ejected from the gas ejecting portion B flows along the outer periphery of the nozzle tip 40 and is ejected so as to converge conically. The gas is then caused to obliquely collide with the liquid. Since the liquid is ejected in a flat film-like shape, a contact area of the liquid with respect to the gas is large, which facilitates the atomization of the liquid. The liquid is thus sheared and comes into an atomized state.

If the gas is caused to collide with the ejected liquid at a right angle, a colliding force of the gas with respect to the liquid is increased. This increases a shear force which shears the liquid.

On the other hand, if the gas is caused to collide with the ejected liquid at a right angle, the gas collides with the liquid sideways with respect to the liquid ejecting direction, and the liquid is suppressed from flowing in the ejecting direction. This makes it impossible to effectively apply the atomized liquid to a target, and deteriorates a liquid application efficiency.

In this respect, if a collision angle at which the gas collided with the ejected liquid is reduced, the liquid is less likely to be suppressed from flowing in the ejecting direction, and the deterioration of the liquid application efficiency with respect to the target is prevented or reduced. In this case, however, the shear force which shears the liquid is decreased, resulting in inadequate atomization of the liquid and uneven liquid application to the target.

In order to achieve good atomization of the liquid and good application efficiency of the liquid with respect to the target, the front end of the nozzle tip 40 is formed in the truncated conical shape with the cone angle θ ranging from 20° to 90° as explained with reference to FIG. 2.

The inventors found that a flow rate of the gas ejected from the gas ejecting portion B and an ejection velocity of the gas were important in materializing a good atomized state, as described below. The inventors materialized a stable and good atomized state by obtaining proper flow rate and ejection velocity of the gas.

The following description will specifically explain relationship between the liquid atomization and the gas flow rate and ejection velocity, and will further explain a configuration of the present invention based on the relationship.

For example, if the flow rate of the gas ejected from the gas ejecting portion B is increased to make a large amount of gas collide with the liquid, the shear force is increased, and the liquid can be efficiently atomized.

However, in case that the atomization takes place using a large amount of gas, some of the liquid is overly atomized. The liquid that is overly atomized spatters before being applied to the target and fails to reach the target, which deteriorates the application efficiency.

If the gas flow rate is reduced, the shear force is decreased. In this case, some of the liquid is not sufficiently atomized, which contributes to uneven liquid application with respect to the target.

The conventional art described above provides auxiliary air holes. It seems that the auxiliary air hole supplies air flow for assisting the atomization of part of sprayed liquid, which is likely to be insufficiently atomized, and therefore enables a generally good atomization.

However, if atomization is carried out without using the auxiliary gas holes, some of the liquid is overly atomized when the flow rate of the gas ejected from the gas ejecting portion B is increased. If the gas flow rate is reduced, some of the liquid is insufficiently atomized.

In order to avoid the use of the auxiliary gas holes, it is required to find a new factor that is unrelated to a tradeoff relationship described above.

It is considered difficult to restore the overly atomized state to the state before the atomization. The inventors then conducted their study as to how to solve the insufficiency of the shear force when the gas flow rate is set to such a value that the over atomization does not occur without using the auxiliary air holes.

In other words, the inventors studied as to whether there is any factor that improves the shear force applied to the liquid without changing the gas flow rate while maintaining the gas flow rate that does not incur over atomization.

As a result, the inventors found that, even without changing the gas flow rate, the shear force applied to the liquid can be increased by increasing the ejection velocity of the gas ejected from the gas ejecting portion B.

More specifically, the ejection velocity V(m/sec) of the gas ejected from the gas ejecting portion B is expressed by V=Y/X, where X(m²) is a cross-sectional area of the gas ejecting portion B, and Y(m³/sec) is the flow rate of the gas ejected from the gas ejecting portion B.

As can be seen from the above relationship, the ejection velocity V can be changed by changing the cross-sectional area X of the gas ejecting portion B while the gas flow rate Y is unchanged.

The increase of the ejection velocity V increases the colliding force of the gas with respect to the liquid. It is then possible to increase the shear force which shears the liquid.

Therefore, if the shear force which becomes deficient when the gas flow rate is set to a value that does not incur over atomization is compensated by the ejection velocity, the gas flow rate that does not incur over atomization can be maintained, and the good atomization of the liquid is achieved.

In order to increase the ejection velocity without increasing the flow rate of the gas ejected from the gas ejecting portion B, it is necessary to reduce the cross-sectional area of the gas ejecting portion B.

In other words, it is necessary to reduce a cross-sectional area of the circular slit-like gap formed around the front end of the nozzle tip 40 by the outer periphery of the front end of the nozzle tip 40 and the atomized gas opening portion 63 of the cap face 61.

The cross-sectional area of the circular slit-like gap can be reduced by reducing width of the circular slit-like gap. However, the cross-sectional area increases in proportion to the square of a diameter ratio, so that if the front end of the nozzle tip 40 (diameter of the circular section 44 of the truncated conical front end) has a large outer peripheral diameter, the width of the circular slit-like gap needs to be extremely small.

The diameter of the circular section 44 of the truncated conical front end and the opening diameter of the atomized gas opening portion 63 of the cap face 61, which form the circular slit-like gap, are then required to be made with high accuracy.

Therefore, the circular section 44 of the truncated conical front end is formed to have a small diameter ranging from 0.8 mm to 2.8 mm.

In addition, the inventors found that, when the flow rate of the gas ejected from the circular slit-like gap is set to fall in a range from 40 L/min to 160 L/min as a gas flow rate that does not incur over atomization, the good atomization can be accomplished by adjusting the ejection velocity into a range from 100 m/sec to 2900 m/sec.

The stable and good atomized state can be accomplished especially by setting the ejection velocity into a range from 300 m/sec to 700 m/sec.

The opening diameter of the atomized gas opening portion 63 is preferably equal to or larger than 1.0 mm and less than 3.0 mm so as not only to reduce the cross-sectional area of the gas ejecting portion B and achieve necessary gas ejection velocity but also to secure the gap (clearance) between the truncated conical front end and the atomized gas opening portion 63, which is equal to or larger than approximately 0.1 mm, in consideration of a manufacturing process.

The truncated conical front end of the nozzle tip 40 is preferably positioned to point forward within a distance of 1.0 mm from an inner end face (end face which faces the space A in FIG. 1) of the atomized gas opening portion 63 of the cap face 61 in the liquid ejecting direction.

For example, the truncated conical front end of the nozzle tip 40 is preferably located within 0.6 mm inside the atomized gas opening portion 63 from where the truncated conical front end is in plane with an outer end face (end face on an outlet side) of the atomized gas opening portion 63 of the cap face 61 or located within 0.4 mm outside the outer end face (end face on the outlet side) of the atomized gas opening portion 63 from where the truncated conical front end is in plane with the outer end face of the atomized gas opening portion 63 of the cap face 61.

At the same time, the circular slit-like gap extending along the outer periphery of the front end of the nozzle tip 40 is surely formed by the outer periphery of the front end of the nozzle tip 40 and the atomized gas opening portion 63 of the cap face 61, so that the ejecting state of the ejected gas is properly maintained.

For a more specific example, in a state where a supply pressure (pressure in the space A shown in FIG. 1) of the gas introduced into the circular slit-like gap was 0.1 MPa by setting the diameter of the circular section 44 of the truncated conical front end at 1.9 mm, the opening diameter of the atomized gas opening portion 63 at 2.5 mm, and a supply pressure of the gas to the gas supply port 21 at 0.15 MPa, and if the flow rate of the gas was 70 L/min, and the ejection velocity of the gas ejected from the gas ejecting portion B was 563 m/sec, a very good atomized state was obtained, in which an average particle size was approximately 125 μm.

The horn portion 62 will be explained below.

As shown in FIG. 1, the horn portions 62 is formed to extend from the outer periphery of the cap face 61 in the liquid ejecting direction. A horn portion 62 includes a gas channel formed to extend in the direction where the horn portion 62 extends, that is, the gas channel 62a extending from the outer periphery of the cap face 61 in the liquid ejecting direction.

The pattern-adjusting gas ejecting ports 64 are disposed in a front end-side portion of the horn portion 62. The pattern-adjusting gas ejecting ports 64 eject the gas toward the atomized liquid at a slant with respect to the liquid ejecting direction. The pattern-adjusting gas ejecting ports 64 open in the gas channel 62a.

The present embodiment refers to a case in which two pattern-adjusting gas ejecting ports 64 are provided with respect to each horn portion 62. The number of the pattern-adjusting gas ejecting ports 64 may be changed as necessary.

In the present embodiment, the liquid is ejected in the flat film-like shape when ejected from the front end of the nozzle tip 40. At the same time as the atomization of the liquid by the gas ejected from the gas ejecting portion B, the atomized liquid forms a circular pattern along the ejection pattern of the gas.

The pattern of the atomized liquid can be changed into an oval pattern by causing the gas ejected from the pattern-adjusting gas ejecting ports 64 of the pair of horn portions 62 opposed to each other as shown in FIG. 5, to collide against the atomized liquid in the circular pattern.

The atomized liquid is thus widened in a longitudinal axis direction of the oval to form a pattern suitable to a case in which the liquid is applied to a wide area.

The gas ejected from the pattern-adjusting gas ejecting ports 64 also accelerates the atomization of the liquid and discourages unification of the atomized liquid, to thereby soften particles of the atomized liquid.

However, the acceleration of the atomization preferably takes place slowly to avoid over atomization. To that end, it is preferable that total cross-sectional area of openings of the pattern-adjusting gas ejecting ports 64 is relatively large.

Considering that the gas supplied from the gas supply port 21 shown in FIG. 1 diverges to be supplied to the pattern-adjusting gas ejecting ports 64 and the atomized gas opening portion 63 as described above, it is preferable that, in a state where spray gas pressure, namely, a supply pressure (pressure in the space A shown in FIG. 1) of the gas introduced into the circular slit-like gap is middle-low pressure ranging from 0.05 MPa to 0.2 MPa by setting a supply pressure of the gas supplied to the gas supply port 21 at a value in a range from 0.07 MPa to 0.25 MPa, the total cross-sectional area of the openings of the pattern-adjusting gas ejecting ports 64 is set equal to or larger than 8.5 mm² to slow the acceleration of the atomization, and the number of the pattern-adjusting gas ejecting ports 64 and the opening area of each of the pattern-adjusting gas ejecting ports 64 are set proper in order to obtain the gas ejecting state that allows the pattern adjustment as a primary function to be carried out.

Although the invention has been explained with reference to the specific embodiment, the invention is not limited to the embodiment.

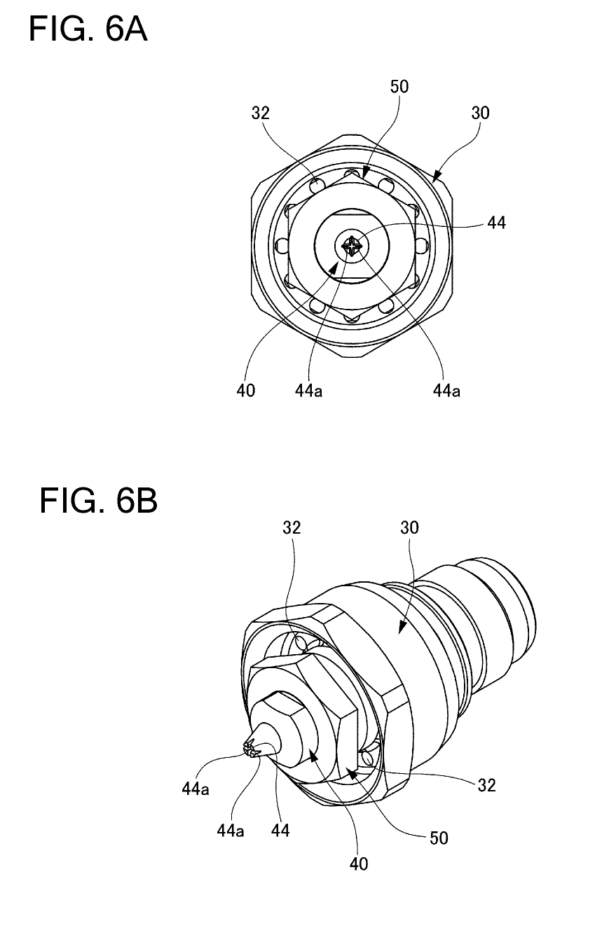

For example, as shown in FIGS. 6A and 6B, it is possible to form two substantially V-shaped grooves 44a in the circular section 44 of the truncated conical front end of the nozzle tip 40 so that the internal hole is opened by arranging the substantially V-shaped grooves 44a in a substantially cross shape in an elevation view to form the liquid ejecting port.

This further increases a surface area of the ejected liquid, which contacts the gas. It is therefore possible to facilitate the atomization and reduce the deficiency amount of the insufficient shear force.

The number of the substantially V-shaped groove 44a is not required to be limited to one. More than one substantially V-shaped groove 44a may be provided to achieve a good atomized state.

As described above, although the ejection pattern of the liquid ejected from the liquid ejecting port 42 is flat, the atomized liquid is formed into the circular pattern along the gas ejection pattern from the gas ejecting portion B at the same time as when atomized by the gas ejected from the gas ejecting portion B. Therefore, the substantially V-shaped groove 44a in the circular section 44 of the truncated conical front end of the nozzle tip 40 is not required to be formed along a perpendicular or horizontal direction as shown in FIGS. 4 and 6. The substantially V-shaped groove 44a may be obliquely formed.

The embodiment refers to a case in which the pair of horn portions 62 are vertically disposed. However, the horn portions 62 may be horizontally disposed, and more than one pair of horn portions 62 may be provided. The number and layout of the horn portions are not limited as long as the atomized liquid in the circular pattern can be properly changed into a predetermined oval pattern.

Needless to say, the invention can be applied to not only liquid such as paint but liquid which needs to be applied in an atomized state.

The invention is not limited to the above-described embodiment. The invention may be appropriately changed or modified. It is obvious from claims to one skilled in the art that such changes and modifications are also included in the technical scope of the invention.

The embodiment makes it possible to provide the spray gun in which the spray gas pressure can be set to relatively low middle-low pressure and which is capable of performing good atomization without making the auxiliary gas holes in the gas cap.

At least the following technical ideas can be understood from the above-described embodiment.

[1] A spray gun comprising:

a nozzle tip (40) in which at least one substantially V-shaped groove (44a) is formed in a circular section (44) of a truncated conical front end with a cone angle ranging from 20° to 90°, and an internal hole is opened by forming the substantially V-shaped groove to provide a liquid ejecting port (42); and

a gas cap (60) including a cap face (61) which is provided with an atomized gas opening portion (63) having an opening diameter larger than the circular section, and a circular slit-like gap (B) that ejects gas for atomizing liquid ejected from the liquid ejecting port is formed between the gas cap and an outer periphery of the truncated conical front end,

wherein the circular section (44) of the truncated conical front end has a diameter ranging from 0.8 mm to 2.8 mm; the atomized gas opening portion (63) has the opening diameter that is equal to or larger than 1.0 mm and smaller than 3.0 mm; a flow rate of the gas ejected from the circular slit-like gap (B) ranges from 40 L/min to 160 L/min; and an ejection velocity of the gas ejected from the circular slit-like gap (B) ranges from 100 m/sec to 2900 m/sec, so that the liquid can be atomized without making auxiliary gas ejecting holes for atomizing the liquid in the cap face (61).

[2] The spray gun described in [1], wherein a supply pressure of the gas at a gas supply port (21) ranges from 0.07 MPa to 0.25 MPa, and a supply pressure at a time when the gas is introduced into the circular slit-like gap (B) ranges from 0.05 MPa to 0.2 MPa.
[3] The spray gun described in either [1] or [2], wherein an ejection velocity of the gas ejected from the circular slit-like gap ranges from 300 m/sec to 700 m/sec.
[4] The spray gun described in any one of [1] to [3], wherein the gas cap (60) includes the horn portions (62) having a gas channel (62a) extending from an outer periphery of the cap face (61) in an ejecting direction of the liquid; the horn portion is provided with the pattern-adjusting gas ejecting ports (64) which ejects gas toward the liquid that is atomized and is open to the gas channel that adjusts a spray pattern with respect to a target to which the atomized liquid is applied.
[5] The spray gun described in [4], wherein the gas cap (60) includes one or more pairs of the horn portions (62) formed to extend in a vertical or horizontal direction of the spray gun.
[6] The spray gun described in [4] or [5],

wherein the gas cap (60) includes one or more pairs of the horn portions (62); and

wherein both end portions of the at least one substantially V-shaped groove (44a) are adjusted to be located on a line connecting the pattern adjusting gas ejecting ports (64) in each of at least one pair of the horn portions.

[7] The spray gun described in any one of [4] to [6],

wherein a total cross-sectional area of openings of the pattern-adjusting gas ejecting ports (64) is equal to or larger than 8.5 mm².

[8] The spray gun described in any one of [1] to [7],

wherein the at least one substantially V-shaped groove (44a) is formed along a vertical, horizontal or oblique direction of the spray gun.

[9] The spray gun described in any one of [1] to [7],

wherein the at least one substantially V-shaped groove (44a) comprises two substantially V-shaped grooves arranged in a substantially cross shape in an elevation view.

[10] The spray gun described in any one of [1] to [9],

wherein the truncated conical front end of the nozzle tip (40) is located between where the truncated conical front end is in plane with an end face of the atomized gas opening portion (63) of the cap face (61), the end face being located on a downstream side of the liquid ejecting direction, and 0.6 mm inside the gas cap (60) or 0.4 mm outside the end face of the atomized gas opening portion (63), which is located on the downstream side of the liquid ejecting direction.

[11] The spray gun described in any one of [1] to [10], comprising:

a liquid nozzle (30) disposed on a front end side of a spray gun body and including a nozzle tip position adjuster (31) on the downstream side of the liquid ejecting direction;

a nozzle tip (40) provided as the nozzle portion that is disposed with a rear end-side portion inserted in the nozzle tip position adjuster (31); and

a nozzle tip holder (50) having an opening (51) through which a front end-side portion of the nozzle tip (40) is inserted and configured to fasten the nozzle tip (40) to the liquid nozzle (30),

wherein the nozzle tip (40) has a tapered portion (43) in which an external diameter of a rear-end outer peripheral surface is reduced toward a rear end;

wherein the liquid nozzle (30) has such a shape that an internal diameter of the nozzle tip position adjuster (31) is reduced toward a rear end of the liquid nozzle (30) correspondingly to the tapered portion (43) of the nozzle tip (40);

wherein a female thread structure (34) that is threadedly engaged with the nozzle tip holder (50) is formed in a front end-side inner peripheral surface of the liquid nozzle (30);

wherein a male thread structure (52) that is threadedly engaged with the female thread structure (34) of the liquid nozzle (30) is formed in a rear end-side outer peripheral surface of the nozzle tip holder (50);

wherein the tapered portion (43) of the nozzle tip (40) is inserted in the nozzle tip position adjuster (31) of the liquid nozzle (30); the nozzle tip holder (50) is then attached to the liquid nozzle (30) so that the front end of the nozzle tip (40) passes through the opening (51) of the nozzle tip holder (50); and the nozzle tip holder (50) is threadedly engaged with the liquid nozzle (30) to fix the nozzle tip (40) to the liquid nozzle (30), so that the tapered portion (43) of the nozzle tip (40) is thus tightly fitted to be sealed to the nozzle tip position adjuster (31), and the nozzle tip (40) is positioned coaxially with the liquid nozzle (30).

[12] The spray gun described in any one of [1] to [11],

wherein the gas cap (60) includes one or more pairs of the horn portions (62) extending from an outer periphery of the cap face (61) in the liquid ejecting direction, and each of the horn portions is provided with the pattern-adjusting gas ejecting ports (64);

wherein the at least one substantially V-shaped groove (44a) is configured to eject liquid in a flat film-like shape from the liquid ejecting port (42);

wherein the circular slit-like gap (B) is configured to eject gas so as to atomize the flat film-like liquid and form the liquid into a circular pattern; and

wherein the pattern-adjusting gas ejecting ports (64) are configured to eject gas so as to shape the circular-pattern atomized liquid into an oval pattern and accelerate atomization.

The foregoing description merely explains several embodiments of the invention. One skilled in the art could easily understand that the embodiments described above may be changed or modified in various ways without substantially deviating from new teachings and advantages of the invention. Therefore, it is intended to include within the technological scope of the invention all aspects added with such changes or modifications.

The embodiments of the invention have been described with reference to several examples to facilitate the understanding of the invention, and the embodiment is not presented to limit the invention. Needless to say, the invention may be changed or modified without deviating from the gist of the invention, and includes equivalents thereof. The constituent elements described in the claims and the description may be arbitrarily combined or omitted within a scope where at least part of the above-mentioned problem can be solved or a scope where at least part of the advantages can be exerted.

The present patent application claims priority to Japanese Patent Application No. 2014-258282 filed on Dec. 22, 2014. The entire disclosure of Japanese Patent Application No. 2014-258282 filed on Dec. 22, 2014 including description, claims, drawings and abstract is incorporated herein by reference in its entirety.

The entire disclosure of Japanese Examined Patent Application Publication No. H07-024796 (Patent Document 1) including description, claims, drawings and abstract is incorporated herein by reference in its entirety.

### REFERENCE SIGNS LIST

10 spray gun
20 spray gun body
21 gas supply port
21a attachment component
22a gas channel
22b gas channel
22c gas channel
22d gas channel
24 trigger
25 needle
25a on-off valve
25b elastic body
26 liquid supply port
26a attachment component
27 pattern adjuster
28 needle
28a front end
29 opening
30 liquid nozzle
31 nozzle tip position adjuster
32 gas channel
33 liquid channel
34 female thread structure
40 nozzle tip
41 liquid channel
42 liquid ejecting port
43 tapered portion
44 circular section
44a substantially V-shaped groove
45 grasped face
45a stepped portion
50 nozzle tip holder
51 opening
52 male thread structure
53 rib
60 gas cap
61 cap face
62 horn portion
62a gas channel
63 atomized gas opening portion
64 pattern-adjusting gas ejecting port
A space
B gas ejecting portion

1. A spray gun comprising:
a nozzle portion in which at least one substantially V-shaped groove is formed in a circular section of a truncated conical front end with a cone angle ranging from 20° to 90°, and an internal hole is opened as a liquid ejecting port by forming the substantially V-shaped groove; and
a gas cap including a cap face which is provided with an atomized gas opening portion having an opening diameter larger than the circular section, the gas cap forming a circular slit-like gap between the gas cap and an outer periphery of the truncated conical front end, the circular slit-like gap being configured to eject gas for atomizing liquid,
wherein the circular section of the truncated conical front end has a diameter ranging from 0.8 mm to 2.8 mm;
wherein the atomized gas opening portion has the opening diameter that is equal to or larger than 1.0 mm and smaller than 3.0 mm; and
wherein the gas is ejected from the circular slit-like gap at a flow rate ranging from 40 L/min to 160 L/min and an ejection velocity ranging from 100 m/sec to 2900 m/sec, so that the liquid can be atomized without providing the cap face with auxiliary gas ejecting holes for atomizing the liquid.

2. The spray gun of claim 1, wherein a supply pressure of the gas at a gas supply port ranges from 0.07 MPa to 0.25 MPa, and a supply pressure at a time when the gas is introduced into the circular slit-like gap ranges from 0.05 MPa to 0.2 MPa.

3. The spray gun of claim 1,
wherein the gas cap includes horn portions having a gas channel extending from an outer periphery of the cap face in an ejecting direction of the liquid; and
wherein the horn portion is provided with pattern-adjusting gas ejecting ports that opens in the gas channel, the pattern-adjusting gas ejecting ports being configured to eject gas toward the liquid that is atomized and adjust a spray pattern shape with respect to a target to be applied with the atomized liquid.

4. The spray gun of claim 1, wherein the truncated conical front end of the nozzle portion is located within 0.6 mm inside the cap from where the truncated conical front end is in plane with a liquid ejecting direction-side end face of the atomized gas opening portion of the cap face or located within 0.4 mm outside the liquid ejecting direction-side end face of the atomized gas opening portion from where the truncated conical front end is in plane with the liquid ejecting direction-side end face of the atomized gas opening portion of the cap face.

5. The spray gun of claim 1, comprising:
a liquid nozzle provided to a front end-side portion of a spray gun body and including a nozzle tip position adjuster located on the liquid ejecting direction side;
a nozzle tip provided as the nozzle portion that is disposed with a rear end-side portion inserted in the nozzle tip position adjuster; and
a nozzle tip holder including an opening through which a front end-side portion of the nozzle tip passes, and configured to fix the nozzle tip to the liquid nozzle,
wherein the nozzle tip includes a tapered portion in which an external diameter of a rear-end outer peripheral surface is reduced toward a rear end;
wherein the liquid nozzle is configured so that an internal diameter of the nozzle tip position adjuster is reduced toward a rear end of the liquid nozzle correspondingly to the tapered portion of the nozzle tip, and that a female thread structure that is threadedly engaged with the nozzle tip holder is formed in a front end-side inner peripheral surface of the liquid nozzle;
wherein the nozzle tip holder is configured so that a male thread structure that is threadedly engaged with the female thread structure of the liquid nozzle is formed in a rear end-side outer peripheral surface of the nozzle tip holder; and
wherein the tapered portion of the nozzle tip is tightly fitted and sealed to the nozzle tip position adjuster, and the nozzle tip is positioned coaxially with the liquid nozzle simply by mounting the nozzle tip holder on the nozzle tip so that the front end of the nozzle tip passes through the opening of the nozzle tip holder, the nozzle tip being positioned so that the tapered portion is inserted in the nozzle tip position adjuster of the liquid nozzle, and threadedly engaging the nozzle tip holder with the liquid nozzle to fix the nozzle tip to the liquid nozzle.
